(19) United States
(12) Patent Application Publication
(10) Pub. No.: US 2002/0136852 A1
(43) Pub. Date: Sep. 26, 2002

(54) Self sticking masking paper for auto painting

(76) Inventor: Joe Fleming, Tucson, AZ (US)

Correspondence Address: BANNER & WITCOFF, 1001 G STREET N W, SUITE 1100, WASHINGTON, DC, 20001, US

(21) Appl. No.: 10/105,813

(22) Filed: Mar. 21, 2002

Related U.S. Application Data
(60) Provisional application No. 60/277,288, filed on Mar. 21, 2001.

(51) Int. Cl. B32B 9/00

(52) U.S. Cl. 428/40.1

(57) ABSTRACT

A protective covering in the form of a mast. The mask is used to protect a surface during the restoration or repair of an automobile or other equipment which has a decorative coating. The mask is formed of a sheet made of a masking material. The sheet has a generally straight edge to which an adhesive strip is attached. A release liner is attached to the adhesive strip and removed when the sheet is to be used.

### REFERENCE TO RELATED APPLICATION

This application claims priority to Provisional Patent Application Serial No. 60/277,288 filed Mar. 21, 2001.

### BACKGROUND OF THE INVENTION

The present invention generally relates to the field of protective coatings and masks that are often used during the restoration or repair of vehicles and other equipment which have a decorative coating. More specifically, the invention is directed to a painting mask for masking various portions of an automobile or other vehicle or craft during a painting operation.

Painting operations often require masking of certain portion of the vehicle to prevent over spray. Removing inadvertent over spray from unprotected areas on the vehicle can be time consuming and risk damaging the original paint on the over sprayed surface. In order to avoid over spray, it is often necessary to mask trim and windows on a vehicle from paint over spray as well as existing painted surfaces. Even in a case where the existing painted surface is theoretically the same color as the new surface to be painted, masking is still necessary in order to prevent minor variations in color between the original and newly painted surfaces from being noticeable on the existing surface.

In addition to masking for the purpose of preventing over spray, masking is often also necessary for surfaces that are susceptible to marring and scratching. For example, during sanding or buffing of an adjacent surface, minute debris from these operations can contaminate and deface unprotected surfaces. Welding and grinding operations also pose the risk of deleterious effects on adjacent surfaces.

Shielding adjacent surfaces from the effects of operations on near by surfaces can be very time consuming and thus expensive, especially when great care must be taken to present even the slightest amount of collateral damage. Such shielding or masking, and the required removable of the masking after a painting operation, can account for a substantial portion of the cost of painting an automobile or any of its parts.

Attempts have been made in the prior art to use forms of chemical masts. These attempts have, for the most part, not been successful. Thus, those who restore and paint vehicles continue to rely on the traditional use of masking tape and paper to cover portions of a vehicle where paint is not desired and to prevent over spray. This is a very labor intensive process and is not fool proof. In many cases after the painting operation, some amount of clear up of adjacent areas will still be necessary.

For all of the above reasons, prior art approaches to masking remain deficient.

### SUMMARY OF THE INVENTION

Accordingly, it is the overall objective of the present invention to overcome the above noted deficiencies in prior art masking approaches and techniques.

It is a specific objective of the present invention to provide a surface mask which is inexpensive and cost effective to manufacture.

It is another specific objective of the present invention to provide a surface mask which is easy to use and effective in masking the surface from the effects of operations on adjacent surfaces.

It is a still further specific objective of the present invention to provide a surface mask which can be easily removed after operations on adjacent surfaces has been completed.

It is another specific objective of the present invention to provide a surface mask which does not harm or mar the surface being protected.

### BRIEF DESCRIPTION OF THE DRAWINGS

The novel features of the present invention are set out with particularity in the appended claims. But the invention will be understood more fully and clearly from the following detailed description of the invention as set forth in the accompanying drawings in which:

FIG. 1 illustrates a masking sheet in accordance with the present invention;

FIG. 2 illustrates the making sheet of the present invention in a role form;

FIG. 3 illustrates the adhesive strip and release liner used with the masking sheet in accordance with the present invention;

FIG. 4 illustrated a plurality of integrally formed masking sheets; and

FIG. 5 illustrates the masking sheet in the form of a master role from which individual roles are cut.

### DESCRIPTION OF THE PREFERRED EMBODIMENT

A preferred embodiment of the present invention will now be described with respect to the accompanying drawings.

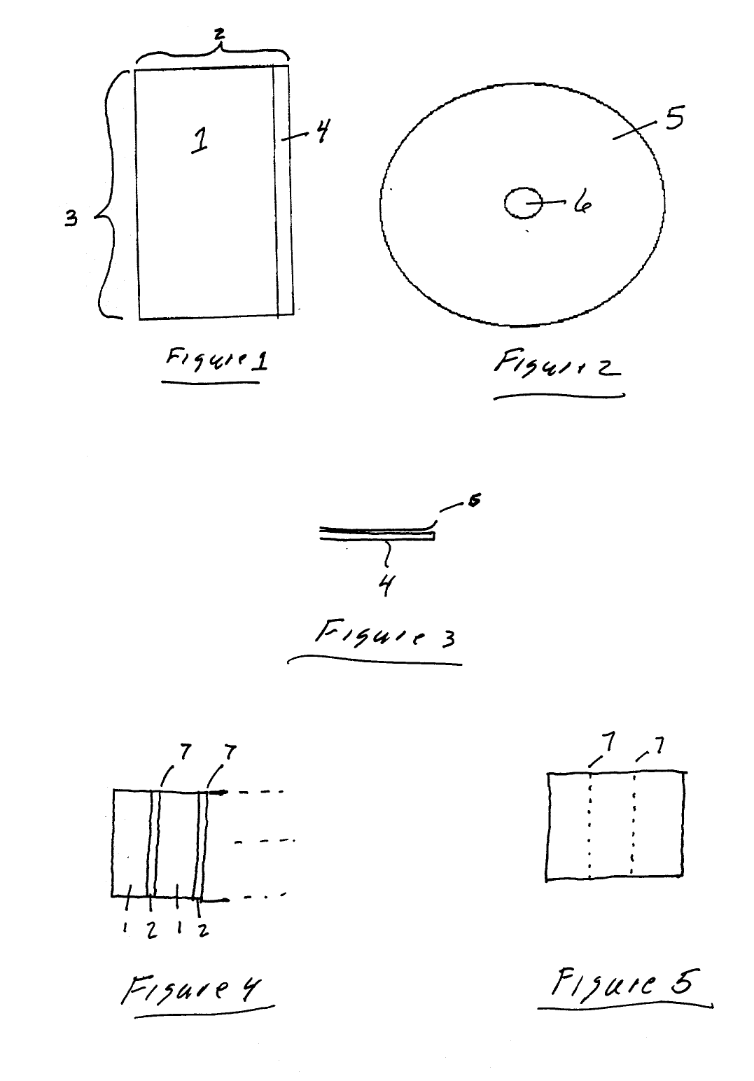

FIG. 1 illustrates masking sheet 1 of the present invention. Sheet 1 may be made from a number of materials known in the prior art which have masking properties for the kinds materials, such as paint and off shoots from grinding and welding, that the mask is expected to encounter. Such masking materials often have a paper base and are well known in the art.

Sheet 1 has a width 2 which can be chosen from a number of widths depending on the size of the area to be masked. A width of 5 inches might be appropriated for some applications while for larger areas, a width of 24 inches might be more appropriate. Sheet 1 also has a length 3. Length 3 also can be chosen from a number of lengths. In accordance with the present invention, sheet 1 can be precut to specific lengths depending on the anticipated sized of the job, or may be formed in a role and cut to length in the field as the size of the job requires. FIG. 2 illustrated sheet 1 formed in a role 5 with a center core 6. The role can be formed in the length wise or width wise direction of the sheet.

Sheet 1 also has an adhesive strip 4 running along an edge of the sheet. This adhesive strip is used to hold or attached sheet 1 to the surface to be protected. Strip 4 can also include a release liner as illustrated by release liner 6 in FIG. 3. As is known in the art, release liner 5 covers and protects the adhesive portion of strip 4 until the sheet 1 is ready to be used. The material used to form release liner 6 is selected from among those known in the art that are customarily used for this purpose.

The width of adhesive strip 4 can be chosen from a number of widths, but a width of ½ inch has been found to be ideal in most applications.

As discussed above, sheet 1 may be formed in a role 5 as illustrated in FIG. 2. Each role may be manufactured individually or may be formed from a master role. FIG. 4 illustrates a plurality of sheets 1 formed together with respective adhesive strips 4. The plurality of integrally formed sheets can then be wound into a master role as illustrated in FIG. 6 and the individual roles formed by splitting the master role along slit points 7 as shown in FIGS. 5 and 6.

It should be obvious from the above-discussed embodiment of the present invention that numerous other variations and modifications of the invention are possible, and such will readily occur to those skilled in the art. Accordingly, the scope of this invention is not to be limited to the embodiment disclosed, but is to include any such embodiments as may be encompassed within the scope of the claims appended hereto.

I claim:

1. A protective masking cover, said masking cover comprising;
a masking sheet made of a masking material having at least one generally straight edge;
an adhesive strip running along said generally straight edge; and
a release liner attached to said adhesive strip.
